(19) United States
(12) Patent Application Publication
(10) Pub. No.: US 2006/0021867 A1
(43) Pub. Date: Feb. 2, 2006

(54) Method and apparatus for converting mixture of water and ethanol into fuel

(76) Inventor: Puhua Zhang, Henan (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/528,121

(22) PCT Filed: Nov. 11, 2002
(86) PCT No.: PCT/CN02/00801

§ 371 Date: Mar. 16, 2005

(30) Foreign Application Priority Data
Sep. 16, 2002 (CN) 02131751.8

(51) Int. Cl. B01J 19/08

(52) U.S. Cl. 204/164; 422/186.04

(57) ABSTRACT

The present invention relates to a method and apparatus for converting the mixture of water and ethanol into fuel. The method comprises mixing water with ethanol in a ratio of 4:1 to 1:1 of water to ethanol by weight, heating and evaporating the obtained mixture to obtain a vapor mixture and passing the said vapor mixture through a DC electric field to convert it to a fuel. The said fuel can use as secondary fuel for engines using gasoline, diesel oil or gas as fuel. The said apparatus includes an evaporating system and DC electric field system.

### FIELD OF TECHNOLOGY

The present invention relates to a method for converting mixture of water and ethanol into fuel and the apparatus thereof. In particular, the present invention relates to a method for converting water into an auxiliary fuel for the heat engines using oil or gas as the fuel, and the apparatus thereof.

### BACKGROUND ART

The hydrogen gas is produced by electrolyzing water, and water can be converted into the fuel due to the combustibility of hydrogen. However, since the electrolysis of water consumes too much power and it is unsafe, the scheme of converting water into fuel by electrolyzing water has not been employed in industry up to the present. A scheme that atomizes water with the ultrasonic technology and then use it as the auxiliary fuel, is not applied in practice due to its impracticability. Patent application No. CN 97107052.0 discloses a technical scheme of converting water into fuel, in which water is reacted in the state of vapor with the action of a catalyst. However, this has not been applied in practice up to the present. Without regard to the technical feasibility and only in review of the economy, this scheme consumes the catalyst, and can occur only under the certain conditions in the reactor. Thus, its apparatus and the process are complicated, and the cost is expensive.

### THE OBJECTIVE OF THE PRESENT INVENTION

The objective of the present invention is to provide a novel method for converting water into fuel which is employed as a auxiliary fuel of the oil and gas used in the existing power equipment to save the energy sources, reduce the consume of the oil and gas and alleviate the environmental pollution, and the apparatus thereof. And the apparatus of the present invention can be operated safely and maintained conveniently and easily.

### THE SUMMARY OF THE PRESENT INVENTION

In order to achieve the above objective, the present invention provides the following technical solution:

The method for converting water into fuel according to the present invention comprises the steps of mixing water with ethanol in a certain ratio by weight, heating and evaporating the mixed solution to obtain a vapor mixture and passing the said vapor mixture through a DC electric field. Then the process of converting water into fuel is finished.

Generally, the mixing ratio of water and ethanol is in a range of 4:1 to 1:1 by weight.

The voltage of the DC electric field is no less than 6V.

In another aspect of the invention, the apparatus for converting water into fuel of the present invention mainly consists of an evaporating system and a DC electric field system, wherein the said evaporating system consists of a tank and an evaporator, and the said DC electric field system consists of a riser pipe, and a negative electrode fixed in the riser pipe and a positive electrode fixed outside the riser pipe. In the evaporating system, a flow control valve is provided between the tank and the evaporator to control the amount of the mixed solution introducing from the tank to the evaporator. The evaporator is of an indirect heating type in which the heating pipe indirectly heats the mixture of the water and the ethanol in the evaporator to convert the said mixture into vapor. The vapor produced in the evaporator is transferred to a reserving vapor pipe through a connecting pipe connected with the evaporator. The reserving vapor pipe is connected to the lower ends of the outer casing of the positive electrode and of the riser pipe in the DC electric field to allow the mixed vapor of water and ethanol in the reserving vapor pipe enter into the DC electric field system. In the DC electric field system of this apparatus, the riser pipe, which separates the negative electrode from the positive electrode, is made of a insulating material. The negative electrode in the riser pipe is opposite to the positive electrode outside of the riser pipe to form the DC electric field. An outlet hole for the fuel gas is formed at the top of the riser pipe and is connected to a fuel gas pipe which is further connected with a fuel gas collecting pipe. An exhausting vent is formed at the top of the outer casing of the positive electrode and is connected to an exhaust gas pipe which is connected with an exhaust gas collecting pipe. The mixed vapor of water and ethanol flows into the DC electric field formed by the negative and positive electrodes, the riser pipe and the outer casing of the positive electrode. With the action of the electric field, the combustible gaseous ion enter into the riser pipe, further enter into the oil-atomizing or gas-atomizing system of an engine through the outlet hole at the top of the riser pipe, the fuel gas pipe and the fuel gas collecting pipe, and is mixed therein and enter into the engine. With the action of the this electric field, the other noncombustible gaseous ion is discharged through the exhausting vent at the top of the outer casing of the positive electrode, the exhaust gas pipe, and the exhaust gas collecting pipe.

In this apparatus, the evaporator is an airtight container through which the heating pipe passes in the center. The mixture of water and ethanol in the evaporator is separated from the material in the heating pipe. The heat is transferred through the wall of the heating pipe to heat and evaporate the mixed solution of water and ethanol into the vapor.

The heating pipe of the evaporating system is a exhausting pipe of the heat engine.

The riser pipe and the negative electrode and the positive electrode in the riser pipe and the positive electrode out of the riser pipe in the DC electric field of this apparatus are connected in a tandem manner or a parallel manner or their combined manner to construct a combined type DC electric field system connected with the reserving vapor pipe, and the output of the system is connected to the fuel gas collecting pipe via the fuel gas pipe, and the noncombustible gas is fed to the exhaust gas collecting pipe (7) via the exhaust pipe

In the DC electric field system of this apparatus, the negative electrode in the riser pipe is a tower-like winding with smaller upperpart and larger underpart or a strip made of a conductive material, and the positive electrode out of the riser pipe and opposite to the negative electrode is a tube electrode which is formed by winding a plate or a strip made of a conductive material around the riser pipe.

In the DC electric field system of this apparatus, the negative electrode is a tube electrode made of a conductive material.

Upon applying and testing, the present invention shows the following advantages and technical effects:
1. The present invention mixes water with ethanol, and heat to evaporate the mixed solution into vapor. Then the vapor mixture passes through a DC electric field. Under the action of the electric field, the combustible gas such as hydrogen gas floats up, and flows into the engine system through the fuel gas pipe and the fuel gas collecting pipe; the oxygen gas and other gases with high unit weight go down, and is exhausted through the exhaust gas pipe and the exhaust gas collecting pipe, so that the invention objective of converting water into fuel is achieved. This fuel can be employed as the auxiliary fuel for the engines using oil or gas as fuel.
2. Upon examining and testing on the gasoline engine, the oil consumption can be reduced by the present invention. Depending on the road conditions and steering status, the average amount of saved fuel oil for the automobile and motorcycle is 10 to 30% provided that the driving skill is almost the same.
3. The combustible gas produced by the present invention doesn't make any erosion or damage to the engine.
4. The apparatus of the present invention has a simple structure, and can be applied to the engines using oil or gas as fuel in the automobile, motorcycle and ship without changing the structure of the engine and the other structures. Only requirement is including the apparatus of the present invention the machines. Therefore, the apparatus of the present invention is likely to be accepted by the manufacturer or the consumer.
5. The power consumption of the DC electric field of the present invention is low, and the evaporator utilizes the remained heat of the engine and has a simple structure. Therefore, the present invention consumes has a low power consumption.
6. The fuel produced by the present invention doesn't make any pollution to the environment, and is a green fuel.
7. The apparatus of the present invention can be operated safely, and maintained easily.
8. The apparatus of the present invention is easy to manufacture with low cost and the raw material is accessible, so it is advantageous to implement and apply the invention.

### BRIEF DESCRIPTION OF THE DRAWINGS

Thereafter, the present invention will be described more detail in conjunction with the accompanying drawings and the embodiment.

FIG. 1 is the full sectioned view illustrating the structure of the apparatus of converting the water into the fuel.

FIG. 2 is the structural schematic of the preferred embodiment with the parallel combined type DC electric field system.

FIG. 3 is the cutaway view of the FIG. 2 along the line A-A.

### EMBODIMENT

### EXAMPLE 1

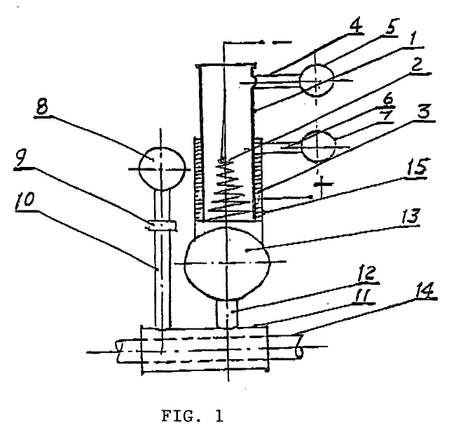

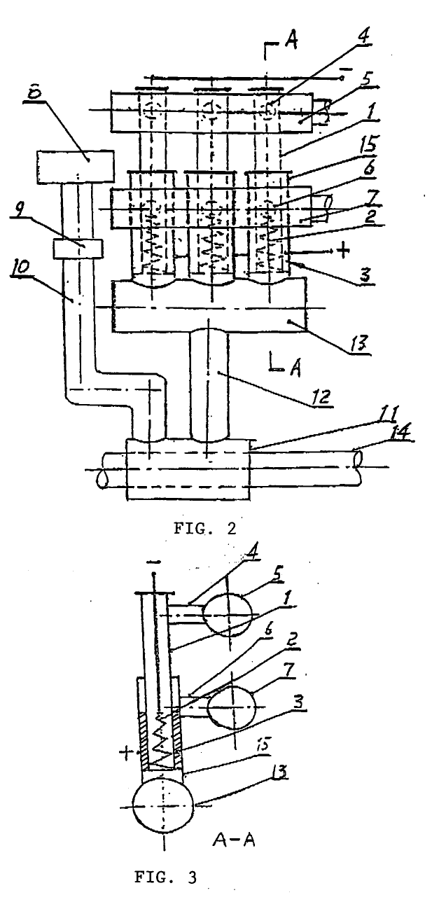

As showed in the FIG. 1, FIG. 2 and FIG. 3, as the preferred example of the present invention, the apparatus for converting water into fuel according to the present invention mainly consists of an evaporating system and a DC electric field system. The evaporating system consists mainly of a tank 8, a flow control valve 9, and an evaporator 11 which are connected in sequence by a connecting pipe 10. The evaporator is airtight container through which the heating pipe 14 passes in the center. The thermal medium in the heating pipe 14 transfers the heat to the mixed solution of water and ethanol, which flows into the evaporator from the tank 8, through the wall of the evaporator, and then the mixed solution is heated and evaporated into the vapor. Water is mixed with ethanol in a ratio by weight of 4:1 to 1:1. The vapor in the evaporator 11 flows into the reserving vapor pipe 13 through a connecting pipe 12 which is connected with the evaporator 11. The DC electric system of this apparatus is of the parallel combined type, in which each of the electric field systems mainly consists of a riser pipe 1 and a negative electrode 2 and a positive electrode 3 fixed in and outside of the lower part of the riser pipe 1. The positive electrode 3 and the negative electrode 2 are opposite each other and are separated by the riser pipe 1 made of a insulating material. The positive electrode 3 is formed with a copper strip winding around the outside wall of the lower part of the riser pipe 1. A outer casing 15 is provided outside of the positive electrode 3. The lower end of the outer casing 15 is connected with the reserving vapor pipe 13, and a exhaust vent is formed at the top of the outer casing 15. The exhaust vent is connected to a exhaust gas collecting pipe 7 through a exhaust gas pipe 6 which is connected with the said exhaust vent. After the vapor flows into the electric field, the produced noncombustible gas enters into the exhaust gas collecting pipe 7 therethrough. The preferred structure of the negative electrode 2 is a tower-like winding with smaller upperpart and larger underpart, which is made of a wire or a strip. The negative electrode 2 is fixed inside the lower part of the riser pipe 1. Thus, the DC electric field is formed between the positive electrode 3 and the negative electrode 2 at the lower part of the riser pipe 1. An outlet hole is formed at the top of the riser pipe 1 and is connected with a fuel gas pipe 4 which is connected to a fuel gas collecting pipe 5. The fuel gas collecting pipe 5 feeds the combustible gas, which is produced after the mixed vapor flowing into the electric field, into the input mechanism of a heat engine as the auxiliary fuel, and the combustible gas is burnt in the air cylinder after being mixed with oil or gas. The lower end of each riser pipe 1 is connected with the reserving vapor pipe 13 to ensure that the vapor enters into the electric field. In the combined electric field of this preferred example, the positive electrode 3 and the negative electrode 2 of each system are connected in parallel, and then are connected to a DC power supply. The voltage of the DC power supply is no less than 6V.

1. A method for converting water into fuel, comprising mixing water with ethanol in a certain ratio by weight, heating and evaporating the obtained mixture to obtain a vapor mixture and passing the said vapor mixture through a DC electric field.

2. The method for converting water into fuel as claimed in claim 1, wherein that the water was mixed with the ethanol in a ratio of 4:1 to 1:1 by weight.

3. The method for converting water into fuel as claimed in claim 1, a voltage of the DC electric field is no less than 6V.

4. An apparatus for converting water into fuel, comprising mainly an evaporating system and a DC electric field system, wherein the said evaporating system consists of a tank and an evaporator, and the said DC electric field system consists of a riser pipe, a negative electrode fixed in the riser pipe and a positive electrode fixed outside of the riser pipe, in the said evaporating system of the apparatus, a flow control valve is provided between the tank and the evaporator, the evaporator is of an indirect heating type in which a heating pipe (14) heats the mixture of water and ethanol indirectly in the evaporator to obtain the mixed vapor, and said vapor produced by the evaporator is transferred into a vapor reserving pipe through a connecting pipe connected with the evaporator, and the vapor reserving pipe is connected with an outer casing of the positive electrode of the DC electric field system and the riser pipe, in the DC electric field system of this apparatus, the riser pipe is made of an insulating material, the negative electrode is fixed inside the riser pipe and the positive electrode corresponding to the negative electrode is fixed outside, the outer casing is equipped around the positive electrode, an outlet hole for the combustible gas is formed at the top of the riser pipe and is connected with a fuel gas pipe which is connected with a fuel gas collecting pipe, and an exhausting vent is formed at the top of the outer casing of the positive electrode and is connected with an exhaust gas pipe which is connected with a exhaust gas collecting pipe.

5. The apparatus for converting water into fuel according to claim 4, wherein the evaporator is an airtight container through which the heating pipe passes in the center, and the mixture of water and ethanol in the evaporator is separated from the material in the heating pipe.

6. The apparatus for converting water into fuel according to claim 5, wherein the heating pipe of the evaporating system is an exhausting pipe of a heat engine.

7. The apparatus for converting water into fuel according to claim 4, wherein the riser pipe and the negative electrode in the riser pipe and the positive electrode out of the riser pipe (1) in the DC electric field of this apparatus are connected in a tandem manner or a parallel manner or the combined manner of them to construct a combined type DC electric field system, which is connected to the reserving vapor pipe, and the output is connected to the fuel gas collecting pipe via the fuel gas pipe and to the exhaust gas collecting pipe via the exhaust pipe (6).

8. The apparatus for converting water into fuel according to claim 4, wherein the negative electrode in the riser pipe is a tower-like winding with larger underpart and smaller upperpart or a strip made of a conductive material, and the positive electrode opposite to the negative electrode is fixed outside of the riser pipe, and is a tube electrode formed by winding a plate or a strip made of a conductive material around the riser pipe.

9. The apparatus for converting water into fuel according to claim 4, wherein the negative electrode in the DC electric field system of said apparatus is a tube electrode made of a conductive material.
